(19) United States
(12) Patent Application Publication
(10) Pub. No.: US 2026/0027635 A1
(43) Pub. Date: Jan. 29, 2026

(54) WEDM-ADAPTED WIRE ELECTRODE AND METHOD FOR MANUFACTURING WEDM-ADAPTED WIRE ELECTRODE

(71) Applicant: Proterial, Ltd., Tokyo (JP)

(72) Inventors: Hiromitsu KURODA, Tokyo (JP); Shingo AMEMIYA, Tokyo (JP); Yosuke SHIBA, Tokyo (JP); Hiroyoshi HIRUTA, Tokyo (JP)

(21) Appl. No.: 19/244,444

(22) Filed: Jun. 20, 2025

(30) Foreign Application Priority Data
Jul. 23, 2024 (JP) 2024-118264
Mar. 27, 2025 (JP) 2025-052947

(51) Int. Cl. B23H 1/06; B23H 7/08

(52) U.S. Cl. CPC B23H 1/06; B23H 7/08

(57) ABSTRACT

A wire electrical discharge machining (WEDM)-adapted wire electrode includes a core material composed of brass having a zinc concentration of greater than 40 mass %, and a coating layer covering a periphery of the core material, wherein the coating layer is composed of brass having a zinc concentration higher than the zinc concentration of the core material and of 44 mass % or more and 50 mass % or less, and wherein a ratio of a thickness of the coating layer to a diameter of the WEDM-adapted wire electrode is 2% or more and 20% or less.

### CROSS-REFERENCE TO RELATED APPLICATIONS

The present patent application claims the priority of Japanese patent application No. 2024-118264 filed on Jul. 23, 2024, and the priority of Japanese patent application No. 2025-052947 filed on Mar. 27, 2025, the entire contents of which are incorporated herein by reference.

### TECHNICAL FIELD

This invention relates to a wire electrode for wire electrical discharge machining (hereinafter referred to as “WEDM-adapted wire electrode”), and a method for manufacturing WEDM-adapted wire electrode.

### BACKGROUND OF THE INVENTION

Conventionally, a WEDM-adapted wire electrode composed of brass and comprising a core material and a coating layer with a higher zinc concentration than the core material covering the periphery of the core material is known (see Patent Literature 1). Since zinc is more likely to generate electric discharges than copper due to its larger work function, a coating layer with a higher zinc concentration surrounding the core material can increase the machining speed of WEDM compared to the case where no coating layer is provided.

### CITATION LIST

Patent Literature 1: JP2024-39167A

### SUMMARY OF THE INVENTION

However, the WEDM-adapted wire electrode described in Patent Literature 1 has a small ratio of the thickness of the coating layer to its diameter, making it unsuitable for high-speed machining where the coating layer is consumed at a high rate during machining.

The object of the present invention is to provide a WEDM-adapted wire electrode with a coating layer composed of brass with a high zinc concentration and having a thickness suitable for high-speed machining, and a manufacturing method thereof.

For solving the above problem, one aspect of the present invention provides a wire electrical discharge machining (WEDM)-adapted wire electrode, comprising: a core material composed of brass having a zinc concentration of greater than 40 mass %; and a coating layer covering a periphery of the core material, wherein the coating layer is composed of brass having a zinc concentration higher than the zinc concentration of the core material and of 44 mass % or more and 50 mass % or less, and wherein a ratio of a thickness of the coating layer to a diameter of the WEDM-adapted wire electrode is 2% or more and 20% or less.

Further, for solving the above problem, another aspect of the present invention provides a wire electrical discharge machining (WEDM)-adapted wire electrode, comprising:
a core material composed of brass having a zinc concentration of greater than 40 mass %; and
a coating layer covering a periphery of the core material,
wherein the coating layer comprises an inner layer and an outer layer covering the inner layer,
wherein the inner layer is composed of brass having a zinc concentration higher than the zinc concentration of the core material and lower than a zinc concentration of brass constituting the outer layer, and
wherein a ratio of a thickness of the coating layer to a diameter of the WEDM-adapted wire electrode is 2% or more and 20% or less.

Still further, for solving the above problem, a still another aspect of the present invention provides A method for manufacturing a wire electrical discharge machining (WEDM)-adapted wire electrode, comprising:
applying heat treatment to a wire material having a core material composed of brass and a zinc film or a brass film having a higher zinc concentration than the core material around the core material, causing atomic diffusion to occur between the core material and the zinc film or the brass film, thereby forming a coating layer covering the core material; and
drawing the wire material after the heat treatment to provide the WEDM-adapted wire electrode,
wherein the WEDM-adapted wire electrode includes the core material composed of brass having a zinc concentration of greater than 40 mass %,
wherein the coating layer is composed of brass having a zinc concentration higher than the zinc concentration of the core material and of 44 mass % or more and 50 mass % or less, wherein a ratio of a thickness of the coating layer to a diameter of the WEDM-adapted wire electrode is 2% or more and 20% or less.

In addition, for solving the above problem, a further aspect of the present invention provides a method for manufacturing a wire electrical discharge machining (WEDM)-adapted wire electrode, comprising:
applying heat treatment to a wire material having a core material 11 composed of brass and a zinc film or a brass film having a higher zinc concentration than the core material around the core material, causing atomic diffusion to occur between the core material and the zinc film or the brass film, thereby forming a coating layer covering the core material; and
drawing the wire material after the heat treatment to provide the WEDM-adapted wire electrode,
wherein the WEDM-adapted wire electrode comprises the core material composed of brass having a zinc concentration of greater than 40 mass %,
wherein the coating layer comprises an inner layer and an outer layer covering the inner layer,
wherein the inner layer is composed of brass having a zinc concentration higher than the zinc concentration of the core material and lower than a zinc concentration of brass constituting the outer layer, and
wherein a ratio of a thickness of the coating layer to a diameter of the WEDM-adapted wire electrode is 2% or more and 20% or less.

### Advantageous Effects of the Invention

According to the present invention, it is possible to provide a WEDM-adapted wire electrode with a coating layer composed of brass with a high zinc concentration and having a thickness suitable for high-speed machining, and a manufacturing method thereof.

### BRIEF DESCRIPTION OF THE DRAWINGS

FIG. 1 is a radial cross-sectional view of a WEDM-adapted wire electrode in an embodiment of the present invention.

FIG. 2 is a schematic diagram showing the state of machining a flat work piece by WEDM.

FIGS. 3A and 3B are microscopic images of a radial cross-section of material A that has been heat-treated at 500° C. for 1 hour and a partially enlarged image thereof.

FIGS. 4A and 4B are microscopic images of a radial cross-section of material B that has been heat-treated at 500° C. for 1 hour and a partially enlarged image thereof.

FIGS. 5A and 5B are SEM observation images of a radial cross-section of material B that has been heat-treated at 400° C. for 1 hour and a partially enlarged image thereof.

FIGS. 6A and 6B are SEM observation images of a radial cross-section of material B that has been heat-treated at 400° C. for 1 hour and a partially enlarged image thereof.

FIGS. 7A and 7B are images observed by an optical microscope of a radial cross-section of a WEDM-adapted wire electrode of 0.3 mm in diameter obtained by drawing material A, which was heat-treated at 500° C. for 1 hour, and a partially enlarged image thereof.

FIGS. 8A and 8B are images observed by an optical microscope of a radial cross-section of a WEDM-adapted wire electrode of 0.3 mm in diameter obtained by drawing material B, which was heat-treated at 500° C. for 1 hour, and a partially enlarged image thereof.

FIGS. 9A and 9B are images observed by an optical microscope of a radial cross-section of a WEDM-adapted wire electrode of 0.3 mm in diameter obtained by drawing material B, which was heat-treated at 400° C. for 1 hour, and a partially enlarged image thereof.

### DETAILED DESCRIPTION OF THE INVENTION

### Embodiment

### (Configuration of WEDM-Adapted Wire Electrode)

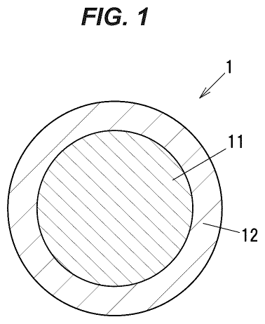

FIG. 1 shows a radial cross-sectional view of a WEDM-adapted wire electrode 1 in an embodiment of the present invention. The WEDM-adapted wire electrode 1 has a core material 11 composed of brass with a zinc (Zn) concentration greater than 40 mass %, and a coating layer 12 provided around the core material 11 and composed of brass with a zinc concentration higher than the core material 11 and 44 mass % or more and 50 mass % or less.

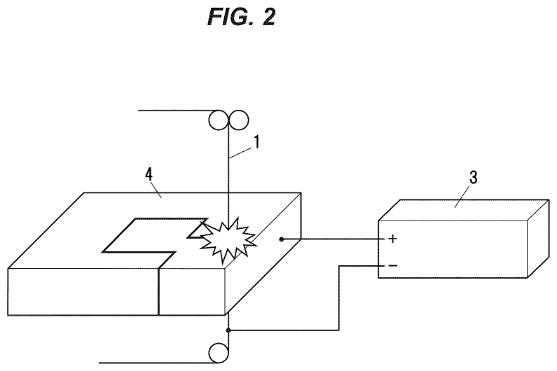

FIG. 2 is a schematic diagram showing the state of machining a flat work piece 4 by WEDM (Wire Electrical Discharge Machining). In WEDM, as shown in FIG. 2, a pulse voltage is applied between the WEDM-adapted wire electrode 1 and the work piece 4 composed of metal material such as SKD-11 by a machining power supply 3 to generate electric discharge between the WEDM-adapted wire electrode 1 and the work piece 4 composed of metal material. In this state, the WEDM-adapted wire electrode 1 is fed and moved against the work piece 4 like a thread saw, and two-dimensional machining is performed on the work piece 4 in a pre-programmed shape.

The WEDM-adapted wire electrode 1 is a wire electrode for high-speed machining. In high-speed machining, a large current is applied to the wire electrode for machining, so the consumption rate of the coating layer is higher than in normal machining. Therefore, in order to avoid the loss of the coating layer 12 during machining, the thickness of the coating layer 12 is thicker than that of general-purpose wire electrodes and wire electrodes for high-precision machining.

The diameter of the WEDM-adapted wire electrode 1 is, e.g., 0.1 mm or more and 0.3 mm or less. The ratio of the thickness of the coating layer 12 to the diameter of the WEDM-adapted wire electrode 1 is 2% or more and 20% or less. If the ratio of the thickness of the coating layer 12 to the diameter of the WEDM-adapted wire electrode 1 is 2% or more, the loss of the coating layer 12 during WEDM can be effectively suppressed, and the machining speed can be reduced due to the loss of the coating layer 12. If the ratio of the thickness of the coating layer 12 to the diameter of the WEDM-adapted wire electrode 1 is 20% or less, the decrease in wire drawability due to an excessively large ratio can be suppressed, and wire breakage during wire drawing can be suppressed in the production of the WEDM-adapted wire electrode 1.

In order to more effectively suppress the loss of the coating layer 12 during WEDM, the ratio of the thickness of the coating layer 12 to the diameter of the WEDM-adapted wire electrode 1 is preferably 3% or more, more preferably 4% or more, and most preferably 10% or more. In order to more effectively suppress the deterioration of wire drawability, the ratio of the thickness of the coating layer 12 to the diameter of the WEDM-adapted wire electrode 1 is more preferably 15% or less.

The zinc concentration of the core material 11 is greater than 40 mass %, as described above, which is higher than the zinc concentration of a core material of conventional general WEDM-adapted wire electrodes. This is to form a thick coating layer 12 in a short time by atomic diffusion as described below. The high zinc concentration of the core material 11 gives it excellent electrical discharge machining performance, which means that even when the coating layer 12 wears away, the machining speed remains faster than conventional materials.

The tensile strength (TS) of the WEDM-adapted wire electrode 1 is, e.g., 800 MPa or more and 1200 MPa or less, the elongation (EL) is, e.g., 0.5% or more and 3% or less, and the electrical conductivity is, e.g., 20% IACS or more and 30% IACS or less.

Here, the tensile strength (TS) of the WEDM-adapted wire electrode 1 is the value measured by the following procedure using the SV-301-E-L tensile and compression testing machine manufactured by Imada Corporation as the measuring device.
(1) First, prepare a WEDM-adapted wire electrode 1 of a predetermined length as a sample.
(2) Fix both ends of the sample to the above measuring device and hold the sample in a straight line.
(3) In this state, pull one end of the sample at a constant speed of 50 mm/min.
(4) Measure the maximum load when the sample breaks (load range: 100N).
(5) Divide the breaking load by the cross-sectional area of the sample to calculate the tensile strength.

The elongation (EL) of the WEDM-adapted wire electrode 1 was measured using the same measuring device used for tensile strength (TS) described above, and the same procedure as described in (1) through (3) above was used. The length between the points when the sample was broken was measured, and the elongation was calculated by the formula “EL=100×(L−L₀)/L₀”. Here, L is the length between the points when the sample broke, and L₀ is the length between the points before the sample was pulled.

The electrical conductivity of the WEDM-adapted wire electrode 1 is the value measured by the method according to JIS H 0505. Here, 8.89 was used as the specific gravity when calculating the electrical conductivity.

### (Method for Manufacturing a WEDM-Adapted Wire Electrode)

An example of a method for manufacturing a WEDM-adapted wire electrode 1 with a wire diameter of 0.25 mm is shown below.

First, a wire-like material with a wire diameter of 1.2 mm, which is the material of the WEDM-adapted wire electrode 1, is prepared. The wire material is, for example, a core material 11, which is a brass wire with a zinc concentration greater than 40 mass % (e.g., 43 mass %) and a zinc film of 8 μm thick formed on the surface of the brass wire. The zinc film is formed by plating or other processes. The wire material is prepared in quantities as required, e.g., 50 kg. Instead of the zinc film, a brass film with a higher zinc concentration than the core material 11 may be used.

Here, in order to make the ratio of the thickness of the coating layer 12 to the diameter of the WEDM-adapted wire electrode 1 be 2% or more and 20% or less, the ratio of the thickness of the galvanized layer to the diameter of the wire material should be, for example, 0.5% or more and 0.9% or less. For example, if the diameter of the wire material is 1.2 mm, the thickness of the galvanized layer should be 6.0 μm or more and 10.8 μm or less.

Next, if the wire material passes the inspection by means of characteristic investigation and visual and cross-sectional observation, the wire material is heat-treated using a furnace to cause atomic diffusion between the core material 11 and the zinc film to form a coating layer 12 composed of brass with a zinc concentration of 44 mass % or more and 50 mass % or less. The thickness of the coating layer 12 after heat treatment is greater than that of the zinc film as a precursor, and the core material 11 is thinner than before heat treatment. The ratio of the thickness T of the coating layer 12 to the diameter D₁ of the wire material, T/D₁, is 2% or more and 20% or less.

As described above, the coating layer 12 is formed thicker than the coating layer of general-purpose wire electrodes and wire electrodes for precision machining. Therefore, in forming the coating layer 12, atomic diffusion is advanced by heat treatment at a higher temperature than that used to form the coating layer of these wire electrodes, for example, at 300° C. or higher and 900° C. or lower. When the heat treatment temperature is 300° C. or higher, the atomic diffusion rate is sufficient to form a thick coating layer 12. When the heat treatment temperature is 900° C. or lower, melting of the brass that constitutes the core material 11 or the coating layer 12 can be easily prevented by adjusting the heat treatment time.

The heat treatment time in the formation of the coating layer 12 is, e.g., 0.2 minutes or more and 120 minutes or less. When the heat treatment time is 0.2 minutes or more, atomic diffusion can sufficiently progress to form a thick coating layer 12. When the heat treatment time is 120 minutes or less, it is easier to prevent the thickness of the coating layer 12 from becoming too large (the ratio of the thickness of the coating layer 12 to the diameter of the WEDM-adapted wire electrode 1 exceeds 20%).

Next, the wire material is passed through a drawing die on a wire drawing machine and drawn to obtain a wire diameter of 0.25 mm to obtain the WEDM-adapted wire electrode 1.

As described above, in the manufacture of the WEDM-adapted wire electrode 1, heat treatment is performed prior to wire drawing. This is because the heat treatment to form the coating layer 12 is performed at the higher temperatures mentioned above. Generally, heat treatment at high temperatures, such as 300° C. to 900° C., is applied to the wire electrode, resulting in a decrease in hardness. Therefore, if heat treatment at high temperatures is performed after wire drawing, the tensile strength of the WEDM-adapted wire electrode 1 as the final product will become smaller.

The WEDM-adapted wire electrode 1 has high tensile strength, e.g., 800 MPa or higher, but such high tensile strength cannot be obtained by the method of performing heat treatment after wire drawing. It is impossible to form a thick coating layer 12 in a realistic amount of time by heat treatment at low temperatures that do not affect the hardness of the wire electrode, e.g., 100° C. to 170° C., because the diffusion rate is significantly reduced.

In order to develop high tensile strength of the WEDM-adapted wire electrode 1, the elongation of the WEDM-adapted wire electrode 1 must be small (for example, when the tensile strength is 800 MPa or more, the elongation is 3% or less). In the method of performing heat treatment after wire drawing, when high temperature treatment is applied to obtain the coating layer 12, it is impossible to reduce elongation to 3% or less because the tensile strength of the WEDM-adapted wire electrode 1 as the final product becomes smaller and elongation becomes larger.

### (Production and Testing of WEDM-Adapted Wire Electrode)

In order to derive the conditions for forming the thick coating layer 12 of the WEDM-adapted wire electrode 1, the wire electrodes were manufactured under various conditions and their structures were examined.

First, heat treatment at 400° C. to 600° C. for 1 hour in an N₂ atmosphere was performed with a wire material 2 with a diameter of 1.2 mm, composed of a core material 11 composed of brass with a zinc concentration of 35% and a copper concentration of 65% and a 10 μm thick zinc plating (i.e., galvanized) film covering the core material 11 (hereinafter referred to as “material A”), as well as a wire material 2 with a diameter of 0.9 mm, composed of a core material 11 composed of brass with a zinc concentration of 43% and a copper concentration of 57% and a 8 μm thick zinc plating film covering the core material 11 (hereinafter referred to as “material B”), for forming a coating layer 12.

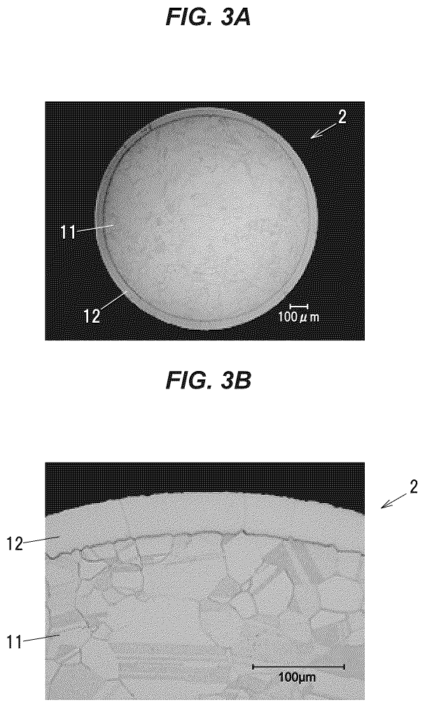

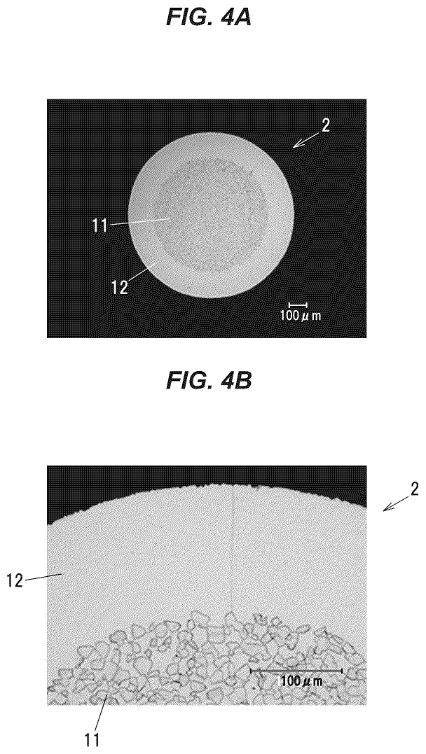

FIGS. 3A and 3B are microscopic images of a radial cross-section of material A that has been heat-treated at 500° C. for 1 hour and a partially enlarged image thereof. FIGS. 4A and 4B are microscopic images of a radial cross-section of material B that has been heat-treated at 500° C. for 1 hour and a partially enlarged image thereof.

As shown in FIGS. 3A, 3B, 4A, and 4B, the thickness of the coating layer 12 is greater for material B than for material A, even though the heat treatment temperatures are the same. This is due to the higher zinc concentration in the core material 11 in material B than in material A.

Next, the radial cross-sections of the heat-treated wire materials 2 (material A and material B) were observed by SEM (Scanning Electron Microscope). The zinc concentration, thickness, and thickness ratio of the coating layer 12 (T/D_{1,} which is the ratio of the thickness T of the coating layer 12 to the diameter D₁ of the wire material 2) obtained from the observation images are shown in Tables 1 and 2 below (all are average values in the observation images).

TABLE 1

| | Wire materials | | | | | |
|---|---|---|---|---|---|---|
| | Material A | | | | | |
| | Heat treatment conditions | | | | | |
| | 400° C. × 1 hr | | 500° C. × 1 hr | | 600° C. × 1 hr | |
| | Coating layer | | | | | |
| | γ-phase | β-phase | γ-phase | β-phase | γ-phase | β-phase |
| Zinc | 55.5 | 47.1 | — | 44.2 | — | 45.7 |
| concentration | | | | | | |
| (mass %) | | | | | | |
| Thickness (μm) | 10 | 19 | — | 46 | — | 49 |
| Thickness | 2.4 | | 3.8 | | 4.1 | |
| ratio (%) | | | | | | |

TABLE 2

| | Wire materials | | | | | |
|---|---|---|---|---|---|---|
| | Material B | | | | | |
| | Heat treatment conditions | | | | | |
| | 400° C. × 1 hr | | 500° C. × 1 hr | | 600° C. × 1 hr | |
| | Coating layer | | | | | |
| | γ-phase | β-phase | γ-phase | β-phase | γ-phase | β-phase |
| Zinc | 56.1 | 47 | — | 44.7 | — | — |
| concentration | | | | | | |
| (mass %) | | | | | | |
| Thickness (μm) | 14 | 19 | — | 135 | — | — |
| Thickness | 3.7 | | 15 | | — | |
| ratio (%) | | | | | | |

As shown in Tables 1 and 2, the thickness ratio of the coating layer 12 is larger for material B than for material A. In addition, the higher the heat treatment temperature, the larger the difference in the thickness ratio of the coating layer 12 between material A and material B. This is due to the higher zinc concentration in the core material 11 in material B than in material A. In material B, the boundary between the core material 11 and the coating layer 12 disappeared due to excessive diffusion between the core material 11 and the coating layer 12 when the material was heat-treated at 600° C. for 1 hour. Therefore, in order to form a WEDM-adapted wire electrode 1 with a coating layer 12 by heat treatment at 600° C., it is necessary to shorten the heat treatment time to the extent that diffusion does not progress excessively.

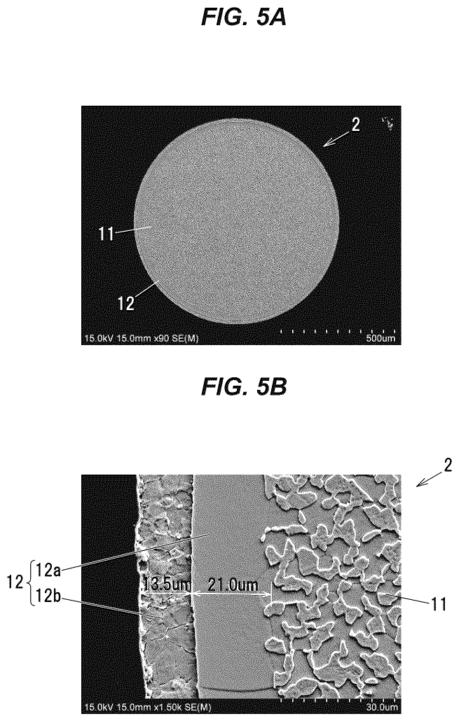

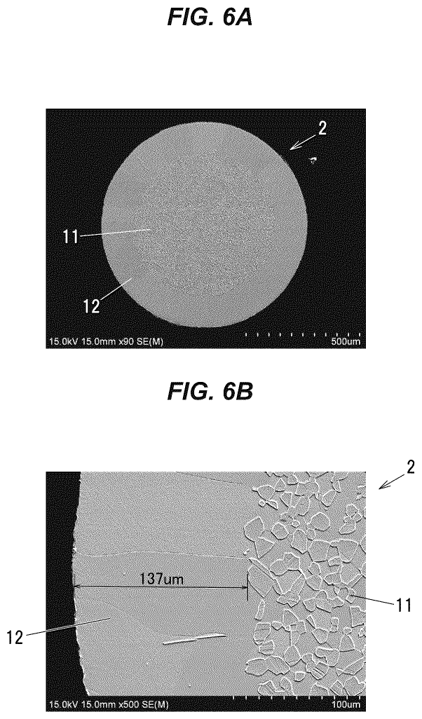

FIGS. 5A and 5B are SEM observation images of a radial cross-section of material B that has been heat-treated at 400° C. for 1 hour and a partially enlarged image thereof. FIGS. 6A and 6B are SEM observation images of a radial cross-section of material B that has been heat-treated at 400° C. for 1 hour and a partially enlarged image thereof.

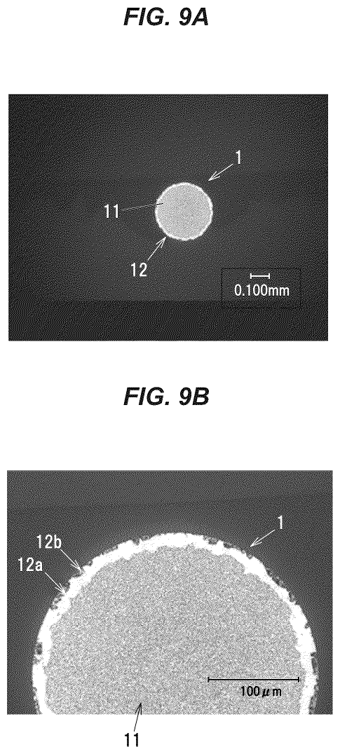

The coating layer 12 is typically composed of β-phase brass, but as shown in Table 2, Table 3, FIGS. 5A, 5B, 9A, and 9B at a relatively low heat treatment temperature of 400° C., the coating layer 12 is composed of an inner layer 12a on the inner side, mainly composed of β-phase brass, and an outer layer 12b, on the outer side, mainly composed of γ-phase brass. As in this case, the coating layer 12 may include the outer layer 12b composed of brass in the γ phase. The β-phase and γ-phase have different zinc concentrations in the brass, and the boundary between the zinc concentrations of the β-phase and γ-phase is about 50 mass %.

For materials A and B, which were heat-treated at 400° C. for 1 hour, the average zinc concentration of the β- and γ-phases is calculated using the thickness and zinc concentration of the β- and γ-phases to be approximately 50%. In other words, the zinc concentration of the entire coating layer 12 is approximately 50%.

The zinc concentrations of the core material 11 and the coating layer 12 in the wire material 2 after heat treatment are almost equal to that of the core material 11 and the coating layer 12 in the WEDM-adapted wire electrode 1 after drawing. Therefore, the range of zinc concentration in the coating layer 12 in the WEDM-adapted wire electrode 1 obtained by drawing material B in this test is approximately between 44 mass % and 50 mass %.

Next, material A and material B, which had been heat-treated at 500° C. for 1 hour, were subjected to drawing by the pultrusion process to form WEDM-adapted wire electrodes 1 with diameters of 0.1 mm to 0.3 mm.

The radial cross-sections of the WEDM-adapted wire electrodes 1 obtained by drawing material A and material B were observed using an optical microscope. The thickness ratios of the coating layer 12 (T/D₂, which is the ratio of the thickness T of the coating layer 12 to the diameter D₂ of the WEDM-adapted wire electrode 1) in the WEDM-adapted wire electrodes 1 obtained from the observation images are shown in Table 3 below.

TABLE 3

| | | Wire electrode diameter | | |
|---|---|---|---|---|
| | | 0.1 mm | 0.2 mm | 0.3 mm |
| Wire | Material A | 3.8% | 3.8% | 3.8% |
| materials | Material B | 15% | 15% | 15% |

As can be seen from Tables 1, 2, and 3, the thickness ratios of the coating layers 12 in the wire material 2 (material A or material B) heat-treated at 500° C. for 1 hour and the WEDM-adapted wire electrodes 1 with a diameter of 0.1 to 0.3 mm obtained by drawing the wire material 2 have the same values. Thus, the thickness ratios of the wire material 2 and the WEDM-adapted wire electrode 1 obtained by drawing the wire material 2 are almost equal.

Table 4 shows the thickness ratios of the coating layer 12 in the WEDM-adapted wire electrodes 1, when material A and material B, which had been heat-treated at 400° C. for 1 hour, were subjected to drawing by the pultrusion process to form WEDM-adapted wire electrodes 1 with diameters of 0.1 mm to 0.3 mm.

TABLE 4

| | | Wire electrode diameter | | |
|---|---|---|---|---|
| | | 0.1 mm | 0.2 mm | 0.3 mm |
| Wire | Material A | 2.4% | 2.4% | 2.4% |
| materials | Material B | 3.7% | 3.7% | 3.7% |

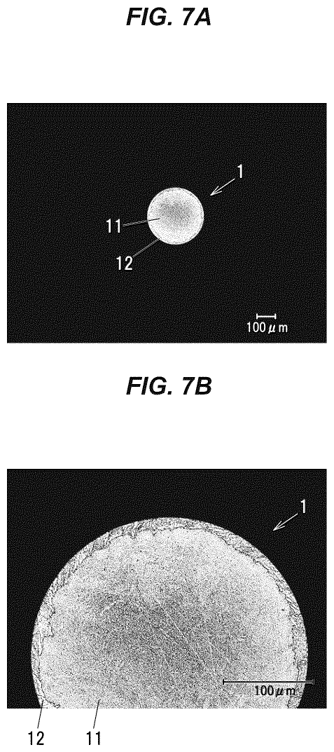

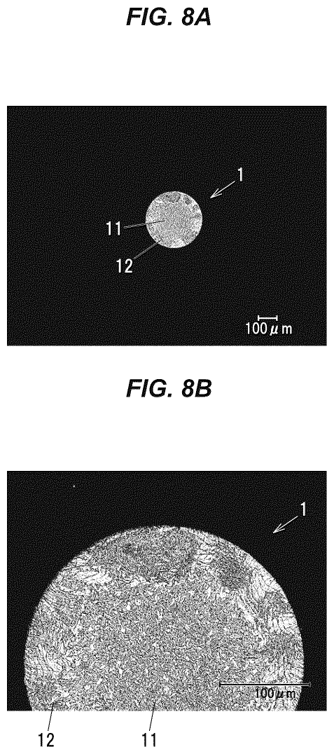

FIGS. 7A and 7B are images observed by an optical microscope of a radial cross-section of a WEDM-adapted wire electrode 1 of 0.3 mm in diameter obtained by drawing material A, which was heat-treated at 500° C. for 1 hour, and a partially enlarged image thereof. FIGS. 8A and 8B are images observed by an optical microscope of a radial cross-section of a WEDM-adapted wire electrode 1 of 0.3 mm in diameter obtained by drawing material B, which was heat-treated at 500° C. for 1 hour, and a partially enlarged image thereof. FIGS. 9A and 9B are images observed by an optical microscope of a radial cross-section of a WEDM-adapted wire electrode 1 of 0.3 mm in diameter obtained by drawing material B, which was heat-treated at 400° C. for 1 hour, and a partially enlarged image thereof.

As shown in Table 3, FIGS. 7A, 7B, 8A, and 8B, the thickness ratio of the coating layer 12 is larger for the WEDM-adapted wire electrode 1 obtained by drawing material B than for the WEDM-adapted wire electrode 1 obtained by drawing material A. This is due to the fact that the thickness of the coating layer 12 formed by heat treatment is larger for material B than for material A because of the higher zinc concentration in the core material 11.

As can be seen from Tables 2, 4, FIGS. 5A, 5B, 9A and 8B, the thickness ratios of the coating layers 12 in the wire material 2 heat-treated at 400° C. for 1 hour and the WEDM-adapted wire electrodes 1 with a diameter of 0.3 mm obtained by drawing the wire material 2 have the same values.

The WEDM-adapted wire electrode 1 (this example), which is obtained by drawing a wire material 2 composed of material B which has been heat-treated at 400° C. for 1 hour, has a thickness ratio of 3.7% for the coating layer 12. The thickness ratio of the coating layer 12 is almost the same as that of material A which has been heat-treated at 500° C. for 1 hour (comparative example), but the WEDM-adapted wire electrode 1 (the present example), which is obtained by drawing a wire material 2 composed of material B is superior in the following points.

The core material 11 with a large zinc concentration is used in this example, so the diffusion rate is fast and the heat treatment can be performed at 400° C., which is lower temperature than 500° C. The ability to treat at low temperatures means that energy consumption during manufacturing can be reduced.

In this example, the coating layer 12 has the outer layer 12b with a large zinc concentration on the surface layer, which is excellent in electrical discharge performance and improves the machining speed.

The thickness ratio of the coating layer 12 can be increased by changing the temperature setting of the heat treatment conditions in this example to 450° C., for example. In contrast, even if the temperature of the heat treatment condition in the comparative example can be set to 450° C., the increase in the thickness ratio of the coating layer 12 will not be expected.

### Advantageous Effects of the Embodiment

According to the embodiment of the present invention, it is possible to provide a WEDM-adapted wire electrode with a coating layer composed of brass with a high zinc concentration and having a thickness suitable for high-speed machining, and a manufacturing method thereof can be provided.

### Summary of the Embodiment

Next, the technical concepts that can be grasped from the above-described embodiment will be described with the help of the codes, etc. in the embodiment. However, each sign, etc. in the following description is not limited to the members, etc. specifically shown in the embodiment for the constituent elements in the scope of claims.

According to the first feature, a wire electrical discharge machining (WEDM)-adapted wire electrode 1 includes a core material 11 composed of brass having a zinc concentration of greater than 40 mass %, and a coating layer 12 covering a periphery of the core material 11, wherein the coating layer 12 is composed of brass having a zinc concentration higher than that of the core material 11 and of 44 mass % or more and 50 mass % or less, wherein the ratio of the thickness of the coating layer 12 to the diameter of the WEDM-adapted wire electrode 1 is 2% or more and 20% or less.

According to the second feature, a wire electrical discharge machining (WEDM)-adapted wire electrode 1 includes a core material 11 composed of brass having a zinc concentration of greater than 40 mass %, and a coating layer 12 covering a periphery of the core material 11, wherein the coating layer 12 includes an inner layer 12a and an outer layer 12b covering the inner layer 12a, wherein the inner layer 12a is composed of brass having a zinc concentration higher than that of the core material 11 and lower than that of brass constituting the outer layer 12b, wherein the ratio of the thickness of the coating layer 12 to the diameter of the WEDM-adapted wire electrode 1 is 2% or more and 20% or less.

According to the third feature, in the WEDM-adapted wire electrode 1 as described in the second feature, the inner layer 12a is composed of brass having the zinc concentration of 44 mass % or more and 50 mass % or less.

According to the fourth feature, in the WEDM-adapted wire electrode 1 as described in the second feature, the outer layer 12b is composed of brass having the zinc concentration greater than 50 mass %.

According to the fifth feature, in the WEDM-adapted wire electrode 1 as described in any one of the first to fourth features, the tensile strength is 800 MPa or more.

According to the sixth feature, a method for manufacturing a wire electrical discharge machining (WEDM)-adapted wire electrode 1 includes applying heat treatment to a wire material 2 having a core material 11 composed of brass and a zinc film or a brass film having a higher zinc concentration than the core material 11 around the core material 11, causing atomic diffusion to occur between the core material 11 and the zinc film or the brass film, thereby forming a coating layer 12 covering the core material 11, and drawing the wire material 2 after the heat treatment to provide the WEDM-adapted wire electrode 1, wherein the WEDM-adapted wire electrode 1 includes the core material 11 composed of brass having a zinc concentration of greater than 40 mass %, wherein the coating layer 12 is composed of brass having a zinc concentration higher than that of the core material 11 and of 44 mass % or more and 50 mass % or less, wherein the ratio of the thickness of the coating layer 12 to the diameter of the WEDM-adapted wire electrode 1 is 2% or more and 20% or less.

According to the seventh feature, a method for manufacturing a wire electrical discharge machining (WEDM)-adapted wire electrode 1 includes applying heat treatment to a wire material 2 having a core material 11 composed of brass and a zinc film or a brass film having a higher zinc concentration than the core material 11 around the core material 11, causing atomic diffusion to occur between the core material 11 and the zinc film or the brass film, thereby forming a coating layer 12 covering the core material 11, and drawing the wire material 2 after the heat treatment to provide the WEDM-adapted wire electrode 1, wherein the WEDM-adapted wire electrode 1 includes the core material 11 composed of brass having a zinc concentration of greater than 40 mass %, wherein the coating layer 12 includes an inner layer 12a and an outer layer 12b covering the inner layer 12a, wherein the inner layer 12a is composed of brass having a zinc concentration higher than that of the core material 11 and lower than that of brass constituting the outer layer 12b, wherein the ratio of the thickness of the coating layer 12 to the diameter of the WEDM-adapted wire electrode 1 is 2% or more and 20% or less.

According to the eighth feature, in the WEDM-adapted wire electrode 1 as described in the seventh feature, the inner layer 12a is composed of brass having the zinc concentration of 44 mass % or more and 50 mass % or less.

According to the ninth feature, in the WEDM-adapted wire electrode 1 as described in the seventh feature, the outer layer 12b is composed of brass having the zinc concentration greater than 50 mass %.

According to the tenth feature, in the WEDM-adapted wire electrode 1 as described in any one of the sixth to ninth features, the temperature of the heat treatment is 300° C. or more and 900° C. or less.

The invention is not limited to the above embodiment, but can be varied and implemented in various ways within the scope of not departing from the main purpose of the invention. In addition, the above embodiment does not limit the invention as per the claims. It should also be noted that not all of the combinations of features described in the embodiment are essential to the means for solving the problems of the invention.

1. A wire electrical discharge machining (WEDM)-adapted wire electrode, comprising:
a core material composed of brass having a zinc concentration of greater than 40 mass %; and
a coating layer covering a periphery of the core material,
wherein the coating layer is composed of brass having a zinc concentration higher than the zinc concentration of the core material and of 44 mass % or more and 50 mass % or less, and wherein a ratio of a thickness of the coating layer to a diameter of the WEDM-adapted wire electrode is 2% or more and 20% or less.

2. A wire electrical discharge machining (WEDM)-adapted wire electrode, comprising:
a core material composed of brass having a zinc concentration of greater than 40 mass %; and
a coating layer covering a periphery of the core material,
wherein the coating layer comprises an inner layer and an outer layer covering the inner layer,
wherein the inner layer is composed of brass having a zinc concentration higher than the zinc concentration of the core material and lower than a zinc concentration of brass constituting the outer layer, and
wherein a ratio of a thickness of the coating layer to a diameter of the WEDM-adapted wire electrode is 2% or more and 20% or less.

3. The WEDM-adapted wire electrode, according to claim 2, wherein the inner layer is composed of brass having the zinc concentration of 44 mass % or more and 50 mass % or less.

4. The WEDM-adapted wire electrode, according to claim 2, wherein the outer layer is composed of brass having the zinc concentration greater than 50 mass %.

5. The WEDM-adapted wire electrode, according to claim 1, wherein a tensile strength is 800 MPa or more.

6. A method for manufacturing a wire electrical discharge machining (WEDM)-adapted wire electrode, comprising:
applying heat treatment to a wire material having a core material composed of brass and a zinc film or a brass film having a higher zinc concentration than the core material around the core material, causing atomic diffusion to occur between the core material and the zinc film or the brass film, thereby forming a coating layer covering the core material; and
drawing the wire material after the heat treatment to provide the WEDM-adapted wire electrode,
wherein the WEDM-adapted wire electrode includes the core material composed of brass having a zinc concentration of greater than 40 mass %,
wherein the coating layer is composed of brass having a zinc concentration higher than the zinc concentration of the core material and of 44 mass % or more and 50 mass % or less, and
wherein a ratio of a thickness of the coating layer to a diameter of the WEDM-adapted wire electrode is 2% or more and 20% or less.

7. A method for manufacturing a wire electrical discharge machining (WEDM)-adapted wire electrode, comprising:
applying heat treatment to a wire material having a core material 11 composed of brass and a zinc film or a brass film having a higher zinc concentration than the core material around the core material, causing atomic diffusion to occur between the core material and the zinc film or the brass film, thereby forming a coating layer covering the core material; and
drawing the wire material after the heat treatment to provide the WEDM-adapted wire electrode,
wherein the WEDM-adapted wire electrode comprises the core material composed of brass having a zinc concentration of greater than 40 mass %,
wherein the coating layer comprises an inner layer and an outer layer covering the inner layer,
wherein the inner layer is composed of brass having a zinc concentration higher than the zinc concentration of the core material and lower than a zinc concentration of brass constituting the outer layer, and
wherein a ratio of a thickness of the coating layer to a diameter of the WEDM-adapted wire electrode is 2% or more and 20% or less.

8. The WEDM-adapted wire electrode, according to claim 7, wherein the inner layer is composed of brass having the zinc concentration of 44 mass % or more and 50 mass % or less.

9. The WEDM-adapted wire electrode, according to claim 7, wherein the outer layer is composed of brass having the zinc concentration greater than 50 mass %.

10. The WEDM-adapted wire electrode, according to claim 6, wherein temperature of the heat treatment is 300° C. or more and 900° C. or less.
